(19) United States
(12) Patent Application Publication
(10) Pub. No.: US 2019/0073020 A1
(43) Pub. Date: Mar. 7, 2019

(54) DYNAMIC MEMORY OFFLINING AND VOLTAGE SCALING

(71) Applicant: Intel Corporation, Santa Clara, CA (US)

(72) Inventor: Aurelien Mozipo, Portland, OR (US)

(73) Assignee: Intel Corporation, Santa Clara, CA (US)

(21) Appl. No.: 15/693,829

(22) Filed: Sep. 1, 2017

(51) Int. Cl. G06F 1/32

(52) U.S. Cl. CPC G06F 1/3275; G06F 1/324; G06F 12/0246; G06F 1/3287; G06F 1/3296

(57) ABSTRACT

An embodiment of a semiconductor package apparatus may include technology to independently bring a first memory power node one of online and offline based on a runtime memory control signal, and independently bring a second memory power node one of online and offline based on the runtime memory control signal. Other embodiments are disclosed and claimed.

### TECHNICAL FIELD

Embodiments generally relate to memory systems, and more particularly, embodiments relate to dynamic memory offlining and voltage scaling.

### BACKGROUND

A memory subsystem may include dual inline memory modules (DIMMs). In a server, the number of DIMMs in the memory subsystem may consume a significant amount of power.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a memory system according to an embodiment;

FIG. 2 is a block diagram of an example of semiconductor package apparatus according to an embodiment;

FIGS. 3A to 3C are flowcharts of an example of a method of controlling memory according to an embodiment;

FIG. 4 is a block diagram of an example of a memory controller apparatus according to an embodiment;

FIGS. 5A to 5B are block diagrams of an example of an electronic processing system according to an embodiment;

FIG. 6 is a flowchart of an example of a method of offlining a memory power node according to an embodiment;

FIG. 7 is a flowchart of an example of a method of onlining a memory power node according to an embodiment;

FIG. 8 is a flowchart of an example of a method of voltage scaling a memory power node according to an embodiment; and

FIG. 9 is an illustrative diagram of an example of a memory power state configuration table according to an embodiment.

### DESCRIPTION OF EMBODIMENTS

Various embodiments described herein may include a memory component and/or an interface to a memory component. Such memory components may include volatile and/or nonvolatile memory. Nonvolatile memory may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), PCM with switch (PCMS), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for (double data rate (DDR) SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

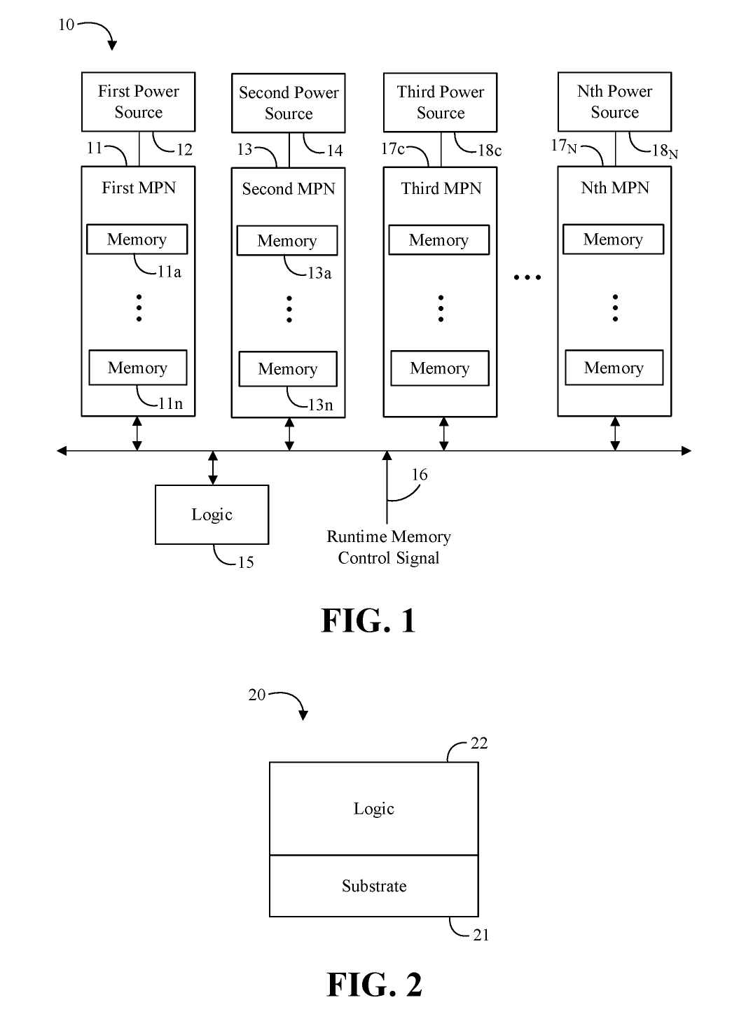

Turning now to FIG. 1, an embodiment of a memory system 10 may include a first memory power node (MPN) 11 (e.g., including a first set of one or more memory devices 11a through 11n), a first power source 12 coupled to the first MPN 11, a second MPN 13 (e.g., including a second set of one or more memory devices 13a through 13n), a second power source 14 coupled to the second MPN 13, and logic 15 coupled to the first MPN 11 and the second MPN 13 to independently bring the first MPN 11 either online or offline based on a runtime memory control signal 16, and independently bring the second MPN 13 either online or offline based on the runtime memory control signal 16. For example, the first power source 12 may be coupled to the first MPN 11 with a first voltage rail, and the second power source 14 may be coupled to the second MPN 13 with a second voltage rail. In some embodiments, a memory power node (MPN) may refer to a set of memory devices all of which are connected to the same voltage rail (e.g., and which may be powered and/or controlled independently of other MPNs).

In some embodiments of the memory system 10, the logic 15 may be further configured to scale a voltage provided to one or more of the first and second MPNs 11, 13 based on the runtime memory control signal 16, and/or scale an operating frequency provided to one or more of the first and second MPNs 11, 13 based on the runtime memory control signal 16. For example, the runtime memory control signal 16 may be based on a memory power state (e.g., as described in more detail herein). In some embodiments, the memory devices may include non-volatile memory (NVM) devices including, for example, non-volatile random access memory (NVRAM) devices. Some embodiments of the memory system 10 may include an additional third MPN 17c through an Nth MPN 17N (e.g., N>2, with each additional MPN including one or more memory devices), independently powered by respective power sources 18c through 18N. The logic 15 may be further configured to online/offline the additional MPNs 17c through 17N, and/or also to scale the voltage and/or operating frequency for the additional MPNs 17c through 17N, based on the runtime memory control signal 16. For example, each of the first MPN 11, the second MPN 13, the third MPN 17c, through the Nth MPN 17N may all be positioned on a same substrate (e.g., a same printed circuit board).

Embodiments of each of the above MPNs, power sources, logic 15, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as RAM, read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory devices, persistent storage media, or other system memory may store a set of instructions which when executed by a processor cause the memory system 10 to implement one or more components, features, or aspects of the system 10 (e.g., the logic 15, onlining a power memory node, offlining a power memory node, voltage scaling, frequency scaling, etc.).

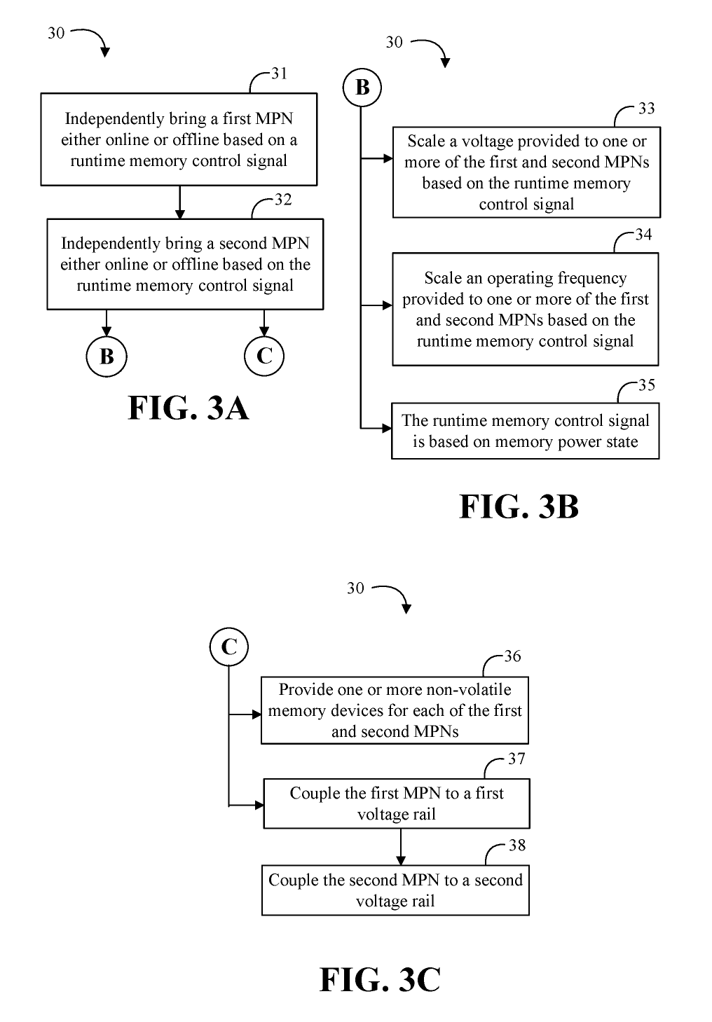

Turning now to FIG. 2, an embodiment of a semiconductor package apparatus 20 may include a substrate 21, and logic 22 coupled to the substrate 21, wherein the logic 22 is at least partly implemented in one or more of configurable logic and fixed-functionality hardware logic. The logic 22 coupled to the substrate may be configured to independently bring a first MPN one of online and offline based on a runtime memory control signal, and independently bring a second MPN one of online and offline based on the runtime memory control signal. In some embodiments, the logic may be further configured to scale a voltage provided to one or more of the first and second MPNs based on the runtime memory control signal, and/or to scale an operating frequency provided to one or more of the first and second MPNs based on the runtime memory control signal. For example, the runtime memory control signal may be based on a memory power state. In some embodiments, the first and second MPNs may each include one or more NVM devices (e.g., NVRAM devices). For example, the first MPN may be coupled to a first voltage rail, while the second MPN may be coupled to a second voltage rail. The logic 22 may be configured (e.g., or configurable) to control additional power memory nodes for onlining, offlining, voltage scaling, and/or frequency scaling.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

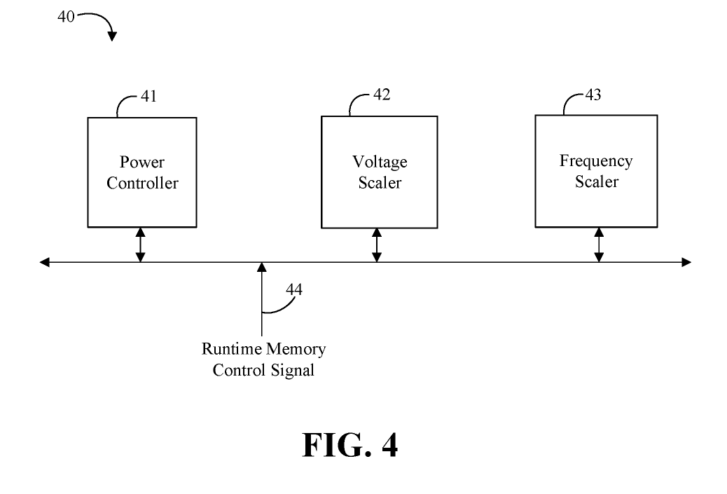

Turning now to FIGS. 3A to 3C, an embodiment of a method 30 of controlling memory may include independently bringing a first MPN one of online and offline based on a runtime memory control signal at block 31, and independently bringing a second MPN one of online and offline based on the runtime memory control signal at block 32. The method 30 may also include scaling a voltage provided to one or more of the first and second MPNs based on the runtime memory control signal at block 33, and scaling an operating frequency provided to one or more of the first and second MPNs based on the runtime memory control signal at block 34. For example, the runtime memory control signal may be based on a memory power state at block 35. Some embodiments of the method 30 may include providing one or more NVM devices for each of the first and second MPNs at block 36, coupling the first MPN to a first voltage rail at block 37, and coupling the second MPN to a second voltage rail at block 38.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 19 to 24 below. Embodiments or portions of the method 30 may be implemented in firmware, applications (e.g., through an application programming interface (API)), or driver software running on an operating system (OS).

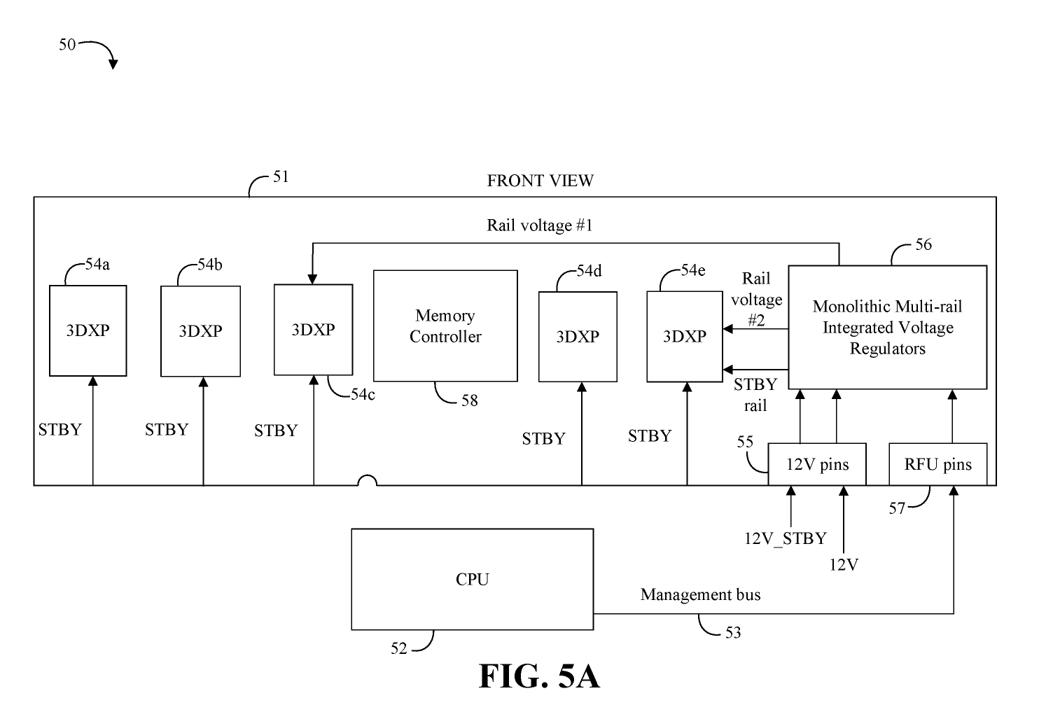

Turning now to FIG. 4, some embodiments may be logically or physically arranged as one or more modules. For example, an embodiment of a memory controller 40 may include a power controller 41, a voltage scaler 42, and a frequency scaler 43. The power controller 41 may be configured to independently bring any of N MPNs (e.g., where N>1) either online or offline based on a runtime memory control signal 44. The voltage scaler 42 may be configured to scale a voltage provided to one or more of the N MPNs based on the runtime memory control signal 44. The frequency scaler 43 may be configured to scale an operating frequency provided to one or more of the N MPNs based on the runtime memory control signal 44. For example, the runtime memory control signal 44 may be based on a memory power state. In some embodiments, the N MPNs may each include one or more NVRAM devices. For example, each of the N MPNs may be respectively coupled to N voltage rails.

Embodiments of the power controller 41, the voltage scaler 42, the frequency scaler 43, and other components of the memory controller 40, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

Some embodiments may advantageously provide memory power saving for 3D cross point memory technology (e.g., INTEL 3D XPOINT), by offlining and/or voltage scaling the memory devices. Some embodiments may also advantageously provide better 3D XPOINT performance, by voltage scaling and/or frequency scaling the memory devices (e.g., where such devices support voltage/frequency scaling). Similarly, some embodiments may advantageously provide memory power saving for other DRAM memory technology, by offlining and/or voltage scaling the DRAM memory devices. Some embodiments may also advantageously provide better DRAM performance, by voltage scaling and/or frequency scaling the DRAM devices (e.g., where such devices support voltage/frequency scaling).

Without being limited to particular applications, some memory subsystems of large memory servers may have high power consumption in runtime and in idle power states. For example, a server for a business or enterprise that mainly operates during business hours (e.g., 9 to 5) may spend a significant percentage of time in idle. The memory not used by the operating system may also consume excessive power while the system is running. Some embodiments may advantageously organize and/or arrange 3D) (POINT integrated circuits (ICs) in ranks and power the ranks with independent voltage rails (e.g., all the voltage rails may be generated from monolithic multi-rail integrated voltage regulators). A control signal bus (e.g. a serial voltage identification (SVID) bus) may then provide an appropriate control signal to a memory controller to perform 3D) (POINT offlining, voltage scaling, and/or frequency scaling. For example, the memory controller may coordinate the voltage scaling with clock frequency scaling to increase memory throughput or reduce power consumption. Advantageously, some embodiments may increase the long-term reliability of 3D XPOINT technology memory devices.

In some embodiments, a dual inline memory module (DIMM) may be configured to offline unneeded 3D XPOINT DRAM ICs (e.g., grouped by ranks) during runtime based on an OS request, online the 3D XPOINT ICs back on as needed, and scale the 3D XPOINT ICs operating voltage/clock frequency to reduce power consumption or to improve performance. As described in more detail herein, the DIMM may include a power architecture to power individual or groups of 3D XPOINT ICs to enable voltage/frequency scaling and offlining/onlining.

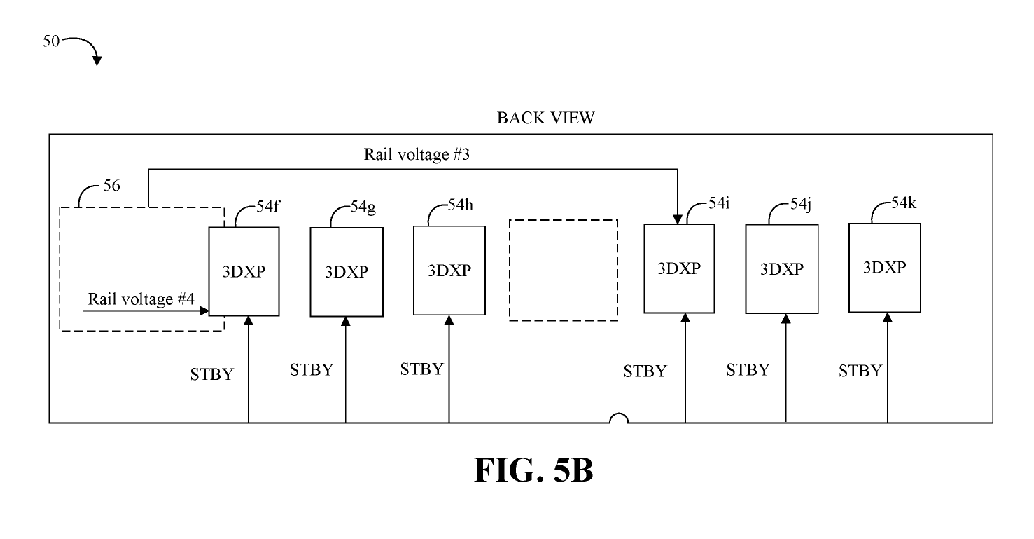

Turning now to FIGS. 5A to 5B, an embodiment of an electronic processing system 50 may include a DIMM 51 communicatively coupled to a central processor unit (CPU) 52 including over a management bus 53 (e.g., an SVID bus). The DIMM may include multiple 3D XPOINT (3DXP) ICs 54a through 54k organized into four ranks. The first rank may include the ICs 54a, 54b, and 54c. The second rank may include the ICs 54d and 54e. The third rank may include the ICs 54f, 54g, and 54h. The fourth rank may include the ICs 54i, 54j, and 54k. For example, each of the first through fourth ranks may correspond to a MPN as discussed above. The DIMM 51 may include power pins including 12V pins 55 respectively coupled to a 12V power source and a 12V standby power source. The 12V power pins 55 may be coupled to a voltage regulator 56 (e.g., monolithic multi-rail integrated voltage regulators) which may be configured to provide a standby rail voltage and separate rail voltages (e.g., rail voltage #1 through #4) for each of the ranks. The management bus 53 may be connected to pins 57 (e.g., reserved for future use (RFU) pins) which may be coupled to the voltage regulator 56. The DIMM 51 may further include a memory controller 58 (e.g., configured to implement one or more aspects of the embodiments described herein).

In some embodiments, the OS may decide during runtime to release unneeded memory space and may inform the basic input/output system (BIOS) to offline the associated rank on a given memory controller. All 3DXP ICs on the rank may then be powered off or entered into a low power mode where only the IC I/O buffers are powered with a standby rail. Monolithic multi-rail integrated voltage regulators may provide power to each rank (e.g., which may include one or multiple 3DXP ICs). The DIMM 51 may alternatively be implemented with single IC per rail or other numbers of multiple 3DXP ICs per voltage rail (e.g., if those ICs are powered on together to preserve functionality, to maximize performance, for space efficiency, etc.). The standby rail may be provided in some embodiments to power only the I/O buffers in offline mode and thus consume reduced or minimum power. In some embodiments, a low current standby rail (e.g., <1 mA/IC) may be routed to the DIMM 51 from a motherboard.

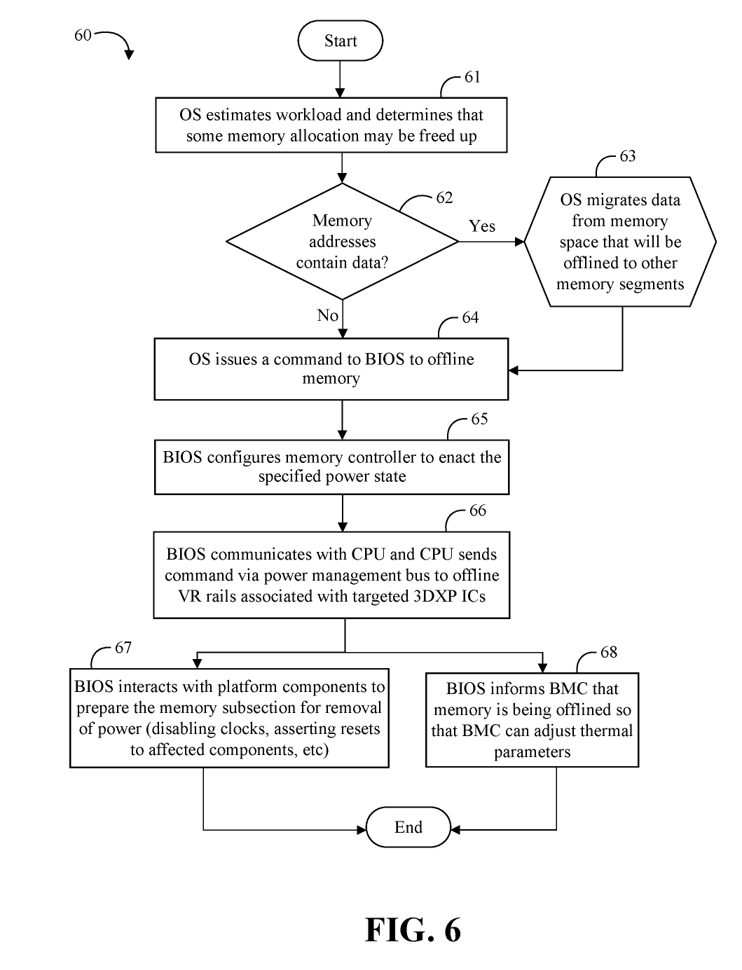

Turning now to FIG. 6, an embodiment of a method 60 of dynamically offlining a MPN may include the OS estimating the workload and determining that some memory allocation may be freed up at block 61. The method 60 may then determine if the memory addresses to be freed contain any data at block 62 and, if so, having the OS migrate the data from the memory space that will be offlined to other memory segments at block 63. If the memory to be offlined contains no data at block 62 (or after the data is migrated at block 63), the OS may issue a command to the BIOS to take the memory offline at block 64. For example, the Advance Configuration and Power Interface (ACPI) specification (e.g., version 6.2, published May 2017 at www.uefi.org/sites/default/files/resources/ACPI_6_2.pdf) may define a format for a configuration table. In some embodiments, the offline command may be issued via an extension specified in a configuration table such as an ACPI table at block 64. This may invoke a system management interrupt (SMI) to do the offline processing. The BIOS may then configure the memory controller to enact the specified power state at block 65. This may involve reconfiguring system address decoders to remove the relevant section of memory residing in the offlined 3D XPOINT IC from the system address map. The BIOS may then communicate with the CPU, and the CPU may send commands via a power management bus (e.g., SVID) to offline the voltage regulator rails associated with the targeted 3DXP IC(s) at block 66. The BIOS may then interact with the platform components to prepare the memory subsection for removal of power (e.g., disabling clocks, asserting resets to affected components, etc.) at block 67, and at the same time the BIOS may inform the baseboard management controller (BMC) that memory is being offlined so that the BMC may adjust the thermal parameters at block 68.

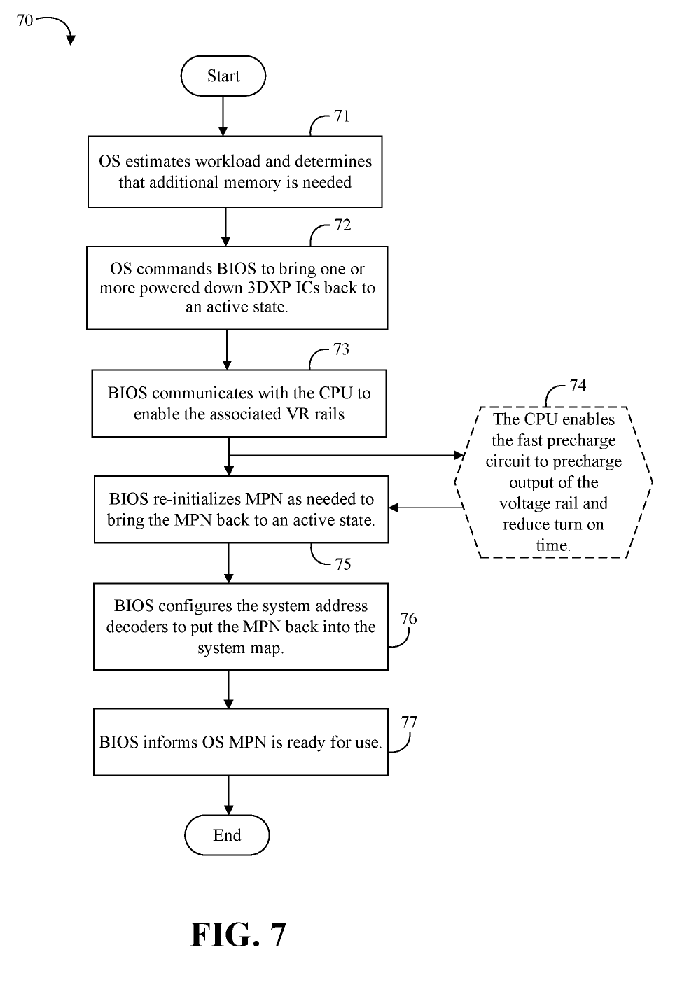

Turning now to FIG. 7, an embodiment of a method 70 of dynamically onlining a MPN may include the OS estimating the workload and determining that additional memory is needed at block 71. The OS may issue a command to the BIOS (e.g., via an extension defined in an ACPI table) to bring offlined memory (e.g., one or more 3DXP ICs) back to an active memory state at block 72. The BIOS may communicate with the CPU to enable the associated voltage regulator rails at block 73. The CPU may optionally also enable a fast precharge circuit to precharge an output of the voltage rail to reduce turn on time at block 74. The BIOS may then re-initialize the MPN as needed to bring the MPN back to an active state at block 75, configure the system address decoders to put the MPN back into the system map at block 76, and inform the OS (e.g., via an ACPI mailbox) that the MPN is ready for use at block 77.

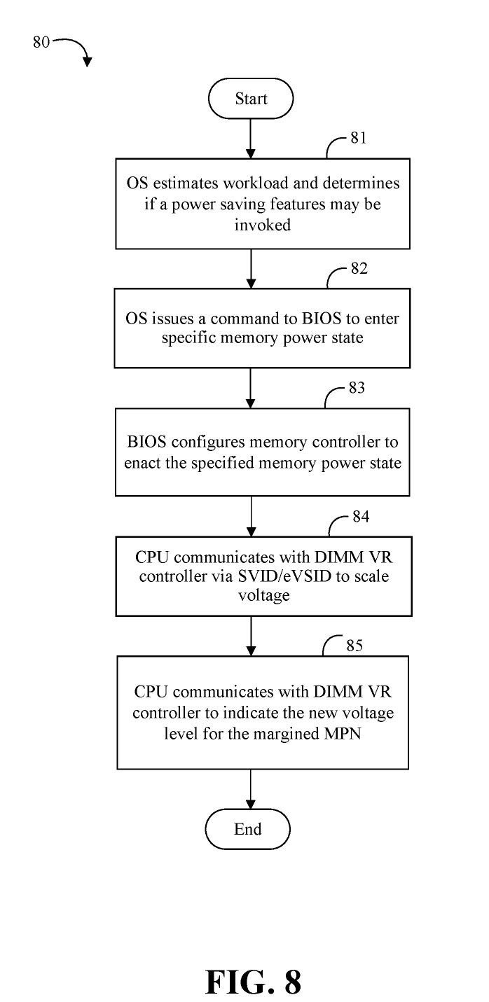

Turning now to FIG. 8, an embodiment of a method 80 of voltage scaling for a MPN may include the OS estimating the workload and determining if a power saving feature may be invoked at block 81. The OS may the issue a command to the BIOS to enter a specific memory power state at block 82 (e.g., as described in more detail below). For example, the memory power states may be defined in a configuration table such as an extension to an ACPI table. For example, the extension to memory power states may define voltage/frequency states at the granularity of one rank/MPN to reduce power and/or increase throughput. In some embodiments, the command from the CPU to the BIOS may invoke a SMI to change memory power states. The BIOS may then configure the memory controller to enact the specified memory power state at block 83, and the CPU may communicate with the DIMM voltage regulator controller (e.g., via SVID or another protocol) to scale voltage at block 84. The CPU may also communicate with the DIMM voltage regulator controller to indicate the new voltage level for the margined MNP at block 85.

Some embodiments may advantageously provide power management for implementation in a datacenter. For example, some embodiments may provide idle memory power reduction (e.g., or even reduction of power in full operation when not all the memory is needed for the workload). In some applications, server may spend a significant amount of time in an idle mode. Selectively offlining some memory in accordance with some embodiments may provide significant power savings in the datacenter. If the datacenter includes DIMMS with 3D cross point technology, some embodiments may increase the mean time between failures (MTBF) of the DIMMs and thus provide long term reliability and service life. When the datacenter workload warrants increased performance, some embodiments may support voltage/frequency scaling to increase memory throughput.

Some embodiments may advantageously provide a memory power state structure for 3D XPOINT based DIMMs. As noted above, idle power consumption may be relatively high in a server with a high memory footprint, due to significant power consumption by the memory subsystem (e.g., the memory subsystem may represent about half of idle power in a 4-socket server). Some embodiments may advantageously provide a structure for memory power states (MPSs) that may reduce the granularity of memory power management down to the level of one rank or MPN (e.g., as opposed to an entire CPU integrated memory controller for the whole memory subsystem, a riser, half-riser, etc.).

As discussed herein, a MPN structure may have finer granularity, which can go down to the level of a memory rank (e.g., a single 3DXP ICs, or a group of 3DXP ICs). Advantageously, in some embodiments the MPN may be power managed by the hardware independently of the OS, or integrated to an OS-directed configuration and power management (OSPM) environment.

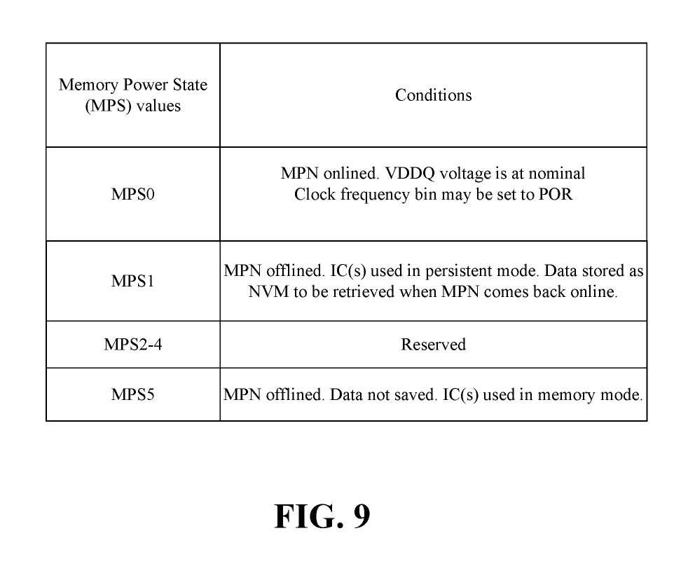

Turning now to FIG. 9, an embodiment of a configuration table may define one or more MPSs. A state value may be associated with a corresponding condition. For example, a MPS0 state may correspond to a condition where the MPN is online and the memory voltage may be set to its nominal operating voltage. In the MPS0 state, the clock frequency bin may be set to the same value as the power-on-reset (POR) value. The MPS0 state may represent the normal operating mode, with no performance boost or offlining (or power savings). An MPS1 state may correspond to a condition where the MPN is offline and the IC(s) may be used in a persistent mode. For example, data stored in NVM may be retrieved when the MPN comes back online. The MPS1 state may provide some power savings because one or more ICs may be powered off (or in a low power standby mode). In some embodiments, the latency of transitioning from the MPS1 state to the MPS0 state may be a few milliseconds (e.g., <3 ms). The MPS2 through MPS4 states may be reserved for future use and may not have an associated condition defined. The MPS5 state may correspond to a condition where the MPN is offline and the data is not saved. For example, the IC(s) may be used in a memory mode (e.g., which may correspond to a system S5 state). The MPS5 state may provide some power savings because one or more ICs may be powered off (or in a low power standby mode). In some embodiments, the latency of transitioning from the MPS5 state to the MPS0 state may be on the order of milliseconds (e.g., <2 ms). Some embodiments may include more or fewer states, and/or may have different conditions associated with the states.

In some embodiments, a MPN may represent the smallest memory block in a 3D XPOINT based DIMM that may be offlined, onlined, or margined (e.g., a minimum number of 3D XPOINT ICs that can be powered off and on independently). All MPNs may be powered by a separate voltage rail and controlled in accordance with the MPSs. The DIMM 51 is an example of a space optimized arrangement of separately powered 3D) (POINT ICs with individual voltage rails. The MPSs discussed in connection with FIG. 9 may be assigned on a node by node basis for fine-grained power management of the MPNs. In some embodiments, the MPS configuration table may be an extension of or linked to an ACPI memory power structure and treated with the same considerations of all ACPI MPST features (e.g., each 3D XPOINT based MPN may be entered in any ACPI states: self-refresh, CKE, etc.).

Some embodiments may advantageously provide finer grain control of memory power in idle (or under reduced workload conditions). In some conventional four slot (4S) servers, the minimum power the DIMMs consume may be about 8 W. Some embodiments may organize the DIMMs in MPNs and at idle or under low load may advantageously place many or all of the MPNs in the MPS1 state which may consume about 0.5 W (e.g., saving about 7.5 W). Some embodiments may also reduce voltage in under a low workload for additional power savings. Voltage margining may be done in tens of millivolts (e.g., about 30 mV) to stay within specs of DDR4 physical layer requirements.

### ADDITIONAL NOTES AND EXAMPLES

Example 1 may include a memory system, comprising a first memory power node including a first set of one or more memory devices, a first power source coupled to the first memory power node, a second memory power node including a second set of one or more memory devices, a second power source coupled to the second memory power node, and logic coupled to the first memory power node and the second memory power node to independently bring the first memory power node one of online and offline based on a runtime memory control signal, and independently bring the second memory power node one of online and offline based on the runtime memory control signal.

Example 2 may include the system of Example 1, wherein the logic is further to scale a voltage provided to one or more of the first and second memory power nodes based on the runtime memory control signal.

Example 3 may include the system of Example 1, wherein the logic is further to scale an operating frequency provided to one or more of the first and second memory power nodes based on the runtime memory control signal.

Example 4 may include the system of any of Examples 1 to 3, wherein the runtime memory control signal is based on a memory power state.

Example 5 may include the system of any of Examples 1 to 3, wherein the memory devices include non-volatile memory devices.

Example 6 may include the system of any of Examples 1 to 3, wherein the first power source is coupled to the first memory power node with a first voltage rail, and wherein the second power source is coupled to the second memory power node with a second voltage rail.

Example 7 may include a semiconductor package apparatus, comprising a substrate, and logic coupled to the substrate, wherein the logic is at least partly implemented in one or more of configurable logic and fixed-functionality hardware logic, the logic coupled to the substrate to independently bring a first memory power node one of online and offline based on a runtime memory control signal, and independently bring a second memory power node one of online and offline based on the runtime memory control signal.

Example 8 may include the apparatus of Example 7, wherein the logic is further to scale a voltage provided to one or more of the first and second memory power nodes based on the runtime memory control signal.

Example 9 may include the apparatus of Example 7, wherein the logic is further to scale an operating frequency provided to one or more of the first and second memory power nodes based on the runtime memory control signal.

Example 10 may include the apparatus of any of Examples 7 to 9, wherein the runtime memory control signal is based on a memory power state.

Example 11 may include the apparatus of any of Examples 7 to 9, wherein the first and second memory power nodes each include one or more non-volatile memory devices.

Example 12 may include the apparatus of any of Examples 7 to 9, wherein the first memory power node is coupled to a first voltage rail, and wherein the second memory power node is coupled to a second voltage rail.

Example 13 may include a method of controlling memory, comprising independently bringing a first memory power node one of online and offline based on a runtime memory control signal, and independently bringing a second memory power node one of online and offline based on the runtime memory control signal.

Example 14 may include the method of Example 13, further comprising scaling a voltage provided to one or more of the first and second memory power nodes based on the runtime memory control signal.

Example 15 may include the method of Example 13, further comprising scaling an operating frequency provided to one or more of the first and second memory power nodes based on the runtime memory control signal.

Example 16 may include the method of any of Examples 13 to 15, wherein the runtime memory control signal is based on a memory power state.

Example 17 may include the method of any of Examples 13 to 15, further comprising providing one or more non-volatile memory devices for each of the first and second memory power nodes.

Example 18 may include the method of any of Examples 13 to 15, further comprising coupling the first memory power node to a first voltage rail, and coupling the second memory power node to a second voltage rail.

Example 19 may include at least one computer readable medium, comprising a set of instructions, which when executed by a computing device, cause the computing device to independently bring a first memory power node one of online and offline based on a runtime memory control signal, and independently bring a second memory power node one of online and offline based on the runtime memory control signal.

Example 20 may include the at least one computer readable medium of Example 19, comprising a further set of instructions, which when executed by the computing device, cause the computing device to scale a voltage provided to one or more of the first and second memory power nodes based on the runtime memory control signal.

Example 21 may include the at least one computer readable medium of Example 19, comprising a further set of instructions, which when executed by the computing device, cause the computing device to scale an operating frequency provided to one or more of the first and second memory power nodes based on the runtime memory control signal.

Example 22 may include the at least one computer readable medium of any of Examples 19 to 21, wherein the runtime memory control signal is based on a memory power state.

Example 23 may include the at least one computer readable medium of any of Examples 19 to 21, comprising a further set of instructions, which when executed by the computing device, cause the computing device to provide one or more non-volatile memory devices for each of the first and second memory power nodes.

Example 24 may include the at least one computer readable medium of any of Examples 19 to 21, comprising a further set of instructions, which when executed by the computing device, cause the computing device to couple the first memory power node to a first voltage rail, and couple the second memory power node to a second voltage rail.

Example 25 may include a memory controller apparatus, comprising means for independently bringing a first memory power node one of online and offline based on a runtime memory control signal, and means for independently bringing a second memory power node one of online and offline based on the runtime memory control signal.

Example 26 may include the apparatus of Example 25, further comprising means for scaling a voltage provided to one or more of the first and second memory power nodes based on the runtime memory control signal.

Example 27 may include the apparatus of Example 25, further comprising means for scaling an operating frequency provided to one or more of the first and second memory power nodes based on the runtime memory control signal.

Example 28 may include the apparatus of any of Examples 25 to 27, wherein the runtime memory control signal is based on a memory power state.

Example 29 may include the apparatus of any of Examples 25 to 27, further comprising means for providing one or more non-volatile memory devices for each of the first and second memory power nodes.

Example 30 may include the apparatus of any of Examples 25 to 27, further comprising means for coupling the first memory power node to a first voltage rail, and means for coupling the second memory power node to a second voltage rail.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system, comprising:
a first memory power node including a first set of one or more memory devices;
a first power source coupled to the first memory power node;
a second memory power node including a second set of one or more memory devices;
a second power source coupled to the second memory power node; and
logic coupled to the first memory power node and the second memory power node, the logic to:
independently bring the first memory power node one of online and offline based on a runtime memory control signal, and
independently bring the second memory power node one of online and offline based on the runtime memory control signal.

2. The system of claim 1, wherein the logic is further to:
scale a voltage provided to one or more of the first and second memory power nodes based on the runtime memory control signal.

3. The system of claim 1, wherein the logic is further to:
scale an operating frequency provided to one or more of the first and second memory power nodes based on the runtime memory control signal.

4. The system of claim 1, wherein the runtime memory control signal is based on a memory power state.

5. The system of claim 1, wherein the memory devices include non-volatile memory devices.

6. The system of claim 1, wherein the first power source is coupled to the first memory power node with a first voltage rail, and wherein the second power source is coupled to the second memory power node with a second voltage rail.

7. An apparatus, comprising:
a substrate; and
logic coupled to the substrate, wherein the logic is at least partly implemented in one or more of configurable logic and fixed-functionality hardware logic, the logic coupled to the substrate to:
independently bring a first memory power node one of online and offline based on a runtime memory control signal, and
independently bring a second memory power node one of online and offline based on the runtime memory control signal.

8. The apparatus of claim 7, wherein the logic is further to:
scale a voltage provided to one or more of the first and second memory power nodes based on the runtime memory control signal.

9. The apparatus of claim 7, wherein the logic is further to:
scale an operating frequency provided to one or more of the first and second memory power nodes based on the runtime memory control signal.

10. The apparatus of claim 7, wherein the runtime memory control signal is based on a memory power state.

11. The apparatus of claim 7, wherein the first and second memory power nodes each include one or more non-volatile memory devices.

12. The apparatus of claim 7, wherein the first memory power node is coupled to a first voltage rail, and wherein the second memory power node is coupled to a second voltage rail.

13. A method comprising:
independently bringing a first memory power node one of online and offline based on a runtime memory control signal; and
independently bringing a second memory power node one of online and offline based on the runtime memory control signal.

14. The method of claim 13, further comprising:
scaling a voltage provided to one or more of the first and second memory power nodes based on the runtime memory control signal.

15. The method of claim 13, further comprising:
scaling an operating frequency provided to one or more of the first and second memory power nodes based on the runtime memory control signal.

16. The method of claim 13, wherein the runtime memory control signal is based on a memory power state.

17. The method of claim 13, further comprising:
providing one or more non-volatile memory devices for each of the first and second memory power nodes.

18. The method of claim 13, further comprising:
coupling the first memory power node to a first voltage rail; and
coupling the second memory power node to a second voltage rail.

19. At least one computer readable medium, comprising a set of instructions, which when executed by a computing device, cause the computing device to:
independently bring a first memory power node one of online and offline based on a runtime memory control signal; and
independently bring a second memory power node one of online and offline based on the runtime memory control signal.

20. The at least one computer readable medium of claim 19, comprising a further set of instructions, which when executed by the computing device, cause the computing device to:
scale a voltage provided to one or more of the first and second memory power nodes based on the runtime memory control signal.

21. The at least one computer readable medium of claim 19, comprising a further set of instructions, which when executed by the computing device, cause the computing device to:
scale an operating frequency provided to one or more of the first and second memory power nodes based on the runtime memory control signal.

22. The at least one computer readable medium of claim 19, wherein the runtime memory control signal is based on a memory power state.

23. The at least one computer readable medium of claim 19, comprising a further set of instructions, which when executed by the computing device, cause the computing device to:
provide one or more non-volatile memory devices for each of the first and second memory power nodes.

24. The at least one computer readable medium of claim 19, comprising a further set of instructions, which when executed by the computing device, cause the computing device to:
couple the first memory power node to a first voltage rail; and
couple the second memory power node to a second voltage rail.
